(19) United States
(12) Patent Application Publication
(10) Pub. No.: US 2026/0202383 A1
(43) Pub. Date: Jul. 16, 2026

(54) GAS CHROMATOGRAPH AND METHOD FOR INTRODUCING SAMPLE GAS IN GAS CHROMATOGRAPH

(71) Applicant: SHIMADZU CORPORATION, Kyoto-shi (JP)

(72) Inventors: Yuichi MIKOTA, Kyoto-shi (JP); Daiki FUKUSHIMA, Kyoto-shi (JP)

(21) Appl. No.: 19/418,433

(22) Filed: Dec. 12, 2025

(30) Foreign Application Priority Data
Jan. 14, 2025 (JP) 2025-004692

(51) Int. Cl. G01N 30/32; B01D 53/02; G01N 30/02

(52) U.S. Cl. CPC G01N 30/32; B01D 53/025; B01D 2259/40003; G01N 2030/025; G01N 2030/324; G01N 2030/328

(57) ABSTRACT

A gas chromatograph comprises a carrier gas supply unit configured to cause a carrier gas at a second pressure higher than a first pressure to flow into the sample loop accommodating the sample gas at the first pressure; a flow rate adjustment chamber configured to adjust a flow rate of a gas passing therethrough; a column configured to separate components of the gas that has flowed in from the flow rate adjustment chamber; a detector configured to detect the components that have flowed in from the column; and a controller configured to adjust the flow rate of the gas passing through the flow rate adjustment chamber. The controller adjusts the flow rate of the flow rate adjustment chamber before the sample gas flows into the flow rate adjustment chamber, to lower a pressure of the flow rate adjustment chamber below the second pressure.

### TECHNICAL FIELD

The present disclosure relates to a gas chromatograph and a method for introducing a sample gas in a gas chromatograph.

### BACKGROUND ART

Generally, a gas chromatograph includes a column that separates components in a sample gas, and a gas sampler that supplies the sample gas to the column. The gas sampler is provided with a sample loop of a predetermined volume, a switching valve for switching the connection of the sample loop, and the like. Japanese Unexamined Patent Application Publication No. 2015-190875 (Patent Literature 1) discloses a gas sampler that employs a six-port valve as the switching valve.

The switching valve is connected to a carrier gas supply unit that supplies a carrier gas, a flow rate adjustment chamber that is provided upstream of the column and adjusts the flow rate of the gas flowing into the column according to the type of the column, and the like.

By controlling the switching valve, it is possible to cause a high-pressure carrier gas to flow into the sample loop that accommodates the sample gas under atmospheric pressure, push out the sample gas, and introduce it into the column via the flow rate adjustment chamber.

### CITATION LIST

### Patent Literature

[Patent Literature 1] Japanese Unexamined Patent Application Publication No. 2015-190875

### SUMMARY OF INVENTION

### Technical Problem

Before and after the sample gas flows in, a carrier gas at a pressure higher than atmospheric pressure flows into the flow rate adjustment chamber. Therefore, only at the moment the sample gas at atmospheric pressure flows in, the pressure in the flow rate adjustment chamber drops, and the flow rate of the gas flowing into the column decreases. This decrease in flow rate becomes a cause of a temporary drop in the detected value (valve shock) in a flow-rate-dependent detector. This valve shock may affect measurement accuracy.

The present disclosure has been made to solve such a problem, and an object thereof is to suppress valve shock and suppress a decrease in measurement accuracy.

### Solution to Problem

A first aspect of the present invention is a gas chromatograph, comprising a sample loop configured to accommodate a sample gas of a predetermined volume; a carrier gas supply unit connected to the sample loop and configured to cause a carrier gas at a second pressure higher than a first pressure to flow into the sample loop accommodating the sample gas at the first pressure; a flow rate adjustment chamber connected to the sample loop and the carrier gas supply unit and configured to adjust a flow rate of a gas passing therethrough; a column connected to the flow rate adjustment chamber and configured to separate components of the gas that has flowed in from the flow rate adjustment chamber; a detector connected to the column and configured to detect the components that have flowed in from the column; and a controller configured to adjust the flow rate of the gas passing through the flow rate adjustment chamber. The controller adjusts the flow rate of the flow rate adjustment chamber before the sample gas flows into the flow rate adjustment chamber, to lower a pressure of the flow rate adjustment chamber below the second pressure.

A second aspect of the present invention is a method for introducing a sample gas in a gas chromatograph. The gas chromatograph comprises a sample loop having a predetermined volume, configured to accommodate a sample gas at a first pressure; a carrier gas supply unit connected to the sample loop and configured to supply a carrier gas at a second pressure higher than the first pressure; a flow rate adjustment chamber connected to the sample loop and the carrier gas supply unit and configured to adjust a flow rate of a gas passing therethrough; a column connected to the flow rate adjustment chamber and configured to separate components of the gas that has flowed in from the flow rate adjustment chamber; and a detector connected to the column and configured to detect the components that have flowed in from the column. The introduction method includes a step of accommodating the sample gas in the sample loop; a step of lowering a pressure of the flow rate adjustment chamber below the second pressure; and a step of causing the carrier gas to flow into the sample loop, thereby pushing the sample gas out from the sample loop and causing it to pass through the flow rate adjustment chamber.

### ADVANTAGEOUS EFFECTS OF INVENTION

According to the present disclosure, it is possible to suppress valve shock and suppress a decrease in measurement accuracy of a gas chromatograph.

### BRIEF DESCRIPTION OF DRAWINGS

FIG. 1 is a schematic configuration diagram of a gas chromatograph according to an embodiment.

FIG. 2 is a schematic diagram of an analysis result of a gas chromatograph according to a comparative example.

FIG. 3 is a flowchart showing a sample gas introduction process according to the embodiment.

FIG. 4 is a schematic diagram of an analysis result of the gas chromatograph according to the embodiment.

### DESCRIPTION OF EMBODIMENTS

Hereinafter, embodiments of the present invention will be described in detail with reference to the drawings. Note that the same or corresponding parts in the drawings are denoted by the same reference numerals, and a description thereof will not be repeated.

### Configuration of Gas Chromatograph

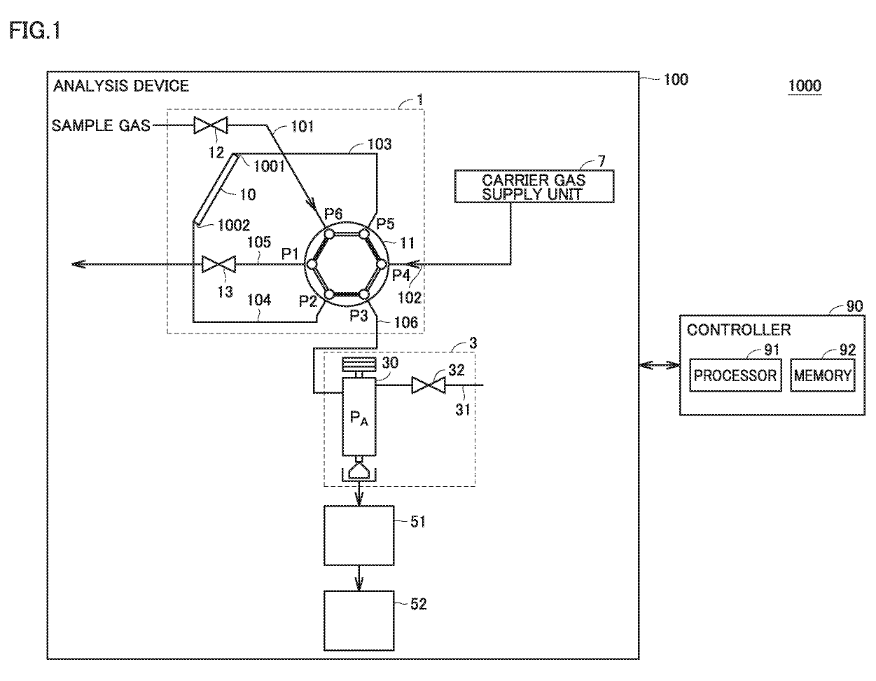

FIG. 1 is a schematic configuration diagram of a gas chromatograph 1000 according to an embodiment. With reference to FIG. 1, the gas chromatograph 1000 includes an analysis device 100 and a controller 90.

The analysis device 100 includes a sampler 1, a carrier gas supply unit 7, a flow rate adjustment unit 3, a column 51, and a detector 52.

The sampler 1 includes a sample loop 10, a switching valve 11, a pressure adjustment valve 12, and a valve 13.

The sample loop 10 has a predetermined volume and measures the sample gas by accommodating the sample gas at a first pressure (for example, atmospheric pressure).

The switching valve 11 switches the connection of the sample loop 10. In one embodiment, the switching valve 11 is a six-port valve having ports P1 to P6.

A pipe 101, into which the sample gas flows, is connected to the port P6. A pressure adjustment valve 12 is installed in the pipe 101.

A pipe 103 and a pipe 104 are connected to the ports P2 and P5, respectively. The pipe 103 and the pipe 104 are connected to a first end 1001 and a second end 1002 of the sample loop 10, respectively.

A vent 105, which is a pipe for discharging the sample gas in the sample loop 10, is connected to the port P1. A valve 13 is installed in the vent 105.

The carrier gas supply unit 7 is connected to the port P4 via a pipe 102. A flow rate adjustment chamber 30 of the flow rate adjustment unit 3 is connected to the port P3 via a pipe 106.

In the switching valve 11, by switching between conduction and non-conduction between adjacent ports, the conduction state between parts connected to the switching valve 11 is switched.

The pressure adjustment valve 12 adjusts the pressure of the sample gas in the sample loop 10 to be the first pressure.

The valve 13 switches between performing and not performing the discharge of the sample gas from the sample loop 10.

The carrier gas supply unit 7 supplies a carrier gas at a second pressure higher than the first pressure. The carrier gas supply unit 7 includes, for example, a cylinder accommodating the carrier gas or a pipe from which the carrier gas flows out. The carrier gas supply unit 7 is connected to the sample loop 10 and the flow rate adjustment chamber 30 via the switching valve 11. The carrier gas supply unit 7 causes the carrier gas to flow into either the sample loop 10 or the carrier gas supply unit 7 that is in conduction in the switching valve 11.

The flow rate adjustment unit 3 includes a flow rate adjustment chamber 30, a vent 31, and a solenoid valve 32. The flow rate adjustment unit 3 adjusts the flow rate of the gas to be introduced into the column 51 by splitting a part of the introduced gas and discharging it to the outside. Thereby, a gas at an appropriate flow rate according to the type of the column 51 can be caused to flow into the column 51.

The flow rate adjustment chamber 30 is connected to the sample loop 10 and the carrier gas supply unit 7 via the switching valve 11. The flow rate adjustment chamber 30 adjusts the flow rate of the gas passing therethrough. In this specification, simply stating "gas" refers to any type of gas, and any type of gas may be a carrier gas or a sample gas.

In one embodiment, the flow rate adjustment chamber 30 may be a chamber (sample vaporization chamber) into which a liquid sample can also be introduced and vaporized.

The vent 31 is a pipe for splitting a part of the gas that has flowed into the flow rate adjustment chamber 30 and discharging it to the outside. The vent 31 corresponds to an embodiment of a "flow rate adjustment vent." The vent 31 is typically provided in an upper part of the flow rate adjustment chamber 30 and is also called a "split vent."

The solenoid valve 32 is controlled by the controller 90 and adjusts the flow rate of the gas discharged from the vent 31. Thereby, the flow rate passing through the flow rate adjustment chamber 30, that is, the flow rate of the gas flowing into the column 51 is adjusted. More specifically, as the controller 90 increases the flow rate of the gas discharged from the vent 31, the flow rate of the gas passing through the flow rate adjustment chamber 30 decreases, and the pressure in the flow rate adjustment chamber 30 drops. As described above, by controlling the solenoid valve 32 by the controller 90, the flow rate and pressure of the flow rate adjustment chamber 30 can be easily adjusted.

The column 51 is connected to the flow rate adjustment chamber 30 and separates components of the gas that has flowed in from the flow rate adjustment chamber 30. Generally, for the column 51, an appropriate flow rate is set according to its type.

The detector 52 is connected to the column 51 and detects components of the gas that has flowed in from the column 51. The detector 52 is generally configured to detect the amount of components in the gas while the flow rate of the gas is constant. In one embodiment, the detector 52 is a flow-rate-dependent detector in which the detected value can fluctuate due to a sudden fluctuation in the gas flow rate.

The controller 90 includes a processor 91 and a memory 92. The processor 91 includes an arithmetic circuit configured with a CPU or the like.

The controller 90 controls the pressure adjustment valve 12 and the switching valve 11 to accommodate the sample gas in the sample loop 10. Specifically, the controller 90 brings the port P6 and the port P5 of the switching valve 11 into conduction and opens the pressure adjustment valve 12, thereby causing the external sample gas to flow into the sample loop 10 via the pipe 101, the switching valve 11, and the pipe 103.

The controller 90 performs an adjustment such that the sample gas at the first pressure is accommodated in the sample loop 10.

In one embodiment, the controller 90 opens the pressure adjustment valve 12 to introduce the sample gas into the sample loop 10, then closes the pressure adjustment valve 12 and waits for a predetermined standby period (for example, a few seconds). If the sample gas introduced into the sample loop 10 is at a pressure higher than the first pressure, a part of the sample gas is discharged by the vent 105 during the standby period, and the pressure in the sample loop 10 is adjusted to the first pressure. Thereby, a constant amount (an amount occupying a predetermined volume at the first pressure) of the sample gas is accommodated in the sample loop 10. Therefore, even if the sample gas before being introduced into the sampler 1 is at a pressure higher than the first pressure or is at the first pressure, the injection volume into the flow rate adjustment chamber 30 can be kept constant. In this specification, "injection of the sample gas" indicates injecting the sample gas into the stream of the flow rate adjustment chamber 30, the column 51, and the detector 52.

The controller 90 controls the switching valve 11 to switch the type of gas flowing into the flow rate adjustment chamber 30. Further, the controller 90 controls the solenoid valve 32 to adjust the flow rate of the gas passing through the flow rate adjustment chamber 30.

The controller 90 controls the switching valve 11 to cause the sample gas in the sample loop 10 to flow into the flow rate adjustment chamber 30. Specifically, the controller 90 brings the port P4 and the port P5, and the port P2 and the port P3 of the switching valve 11 into conduction. Thereby, the carrier gas from the carrier gas supply unit 7 flows into the sample loop 10 and pushes out the sample gas in the sample loop 10. Then, the sample gas pushed out from the sample loop 10 by the carrier gas flows into the flow rate adjustment chamber 30. Then, the sample gas in the flow rate adjustment chamber 30 is pushed out by the subsequent carrier gas and is further sent to the column 51 and the detector 52.

The controller 90 controls the switching valve 11 to cause the carrier gas from the carrier gas supply unit 7 to flow directly into the flow rate adjustment chamber 30. Here, "to cause to flow directly" means to cause to flow without passing through the sample loop 10. Specifically, the controller 90 brings the port P4 and the port P3 of the switching valve 11 into conduction, thereby causing the carrier gas from the carrier gas supply unit 7 to flow into the flow rate adjustment chamber 30 via the pipe 102, the switching valve 11, and the pipe 106.

The controller 90 normally causes the carrier gas from the carrier gas supply unit 7 to flow into the flow rate adjustment chamber 30. Specifically, for example, the controller 90 causes the carrier gas from the carrier gas supply unit 7 to flow into the flow rate adjustment chamber 30 until immediately before causing the sample gas to flow into the flow rate adjustment chamber 30.

The controller 90 according to the present embodiment adjusts the flow rate of the gas passing through the flow rate adjustment chamber 30 before the sample gas flows into the flow rate adjustment chamber 30, and lowers the pressure of the flow rate adjustment chamber 30 below the second pressure, thereby reducing the pressure change in the flow rate adjustment chamber 30 at the time of sample gas injection. This can suppress valve shock, in which the flow rate of the gas flowing into the column decreases due to the pressure change in the flow rate adjustment chamber 30, and the value of the detection signal (signal value) in the detector sharply changes temporarily. Therefore, it is possible to suppress valve shock and suppress a decrease in measurement accuracy of the gas chromatograph.

### Method for Introducing Sample Gas according to Comparative Example

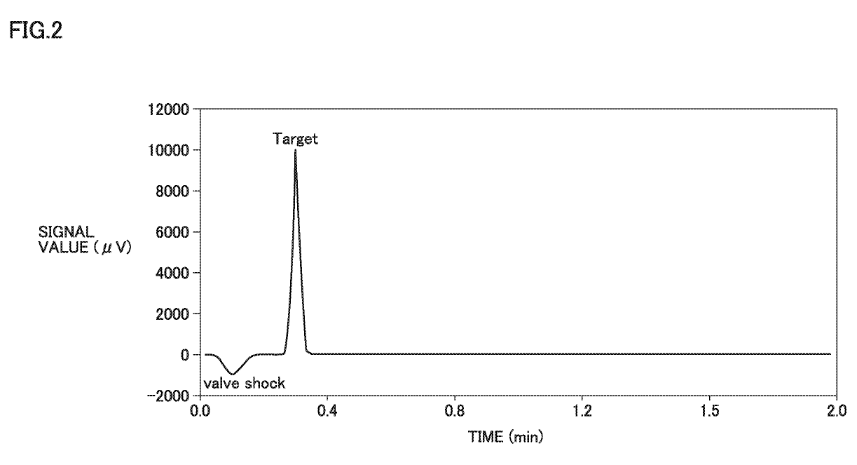

Next, a decrease in measurement accuracy of a gas chromatograph due to valve shock will be specifically described using a comparative example. FIG. 2 is a schematic diagram of an analysis result (chromatogram) of a gas chromatograph according to a comparative example.

Valve shock is caused by the pressure difference between the carrier gas at the second pressure and the sample gas in the sample loop at the first pressure (< second pressure).

In the flow rate adjustment chamber, before the sample gas flows in, the carrier gas at the second pressure is passing through. Next, when the sample gas at the first pressure flows into the flow rate adjustment chamber, the pressure in the flow rate adjustment chamber drops, and the flow rate of the gas flowing into the column also decreases. Then, when the carrier gas at the second pressure, which has pushed the sample gas out from the sample loop, flows into the flow rate adjustment chamber, the pressure in the flow rate adjustment chamber rises again and returns to the second pressure. Thereby, the flow rate of the gas flowing into the column also increases and returns to the flow rate before the inflow of the sample gas. As described above, in the gas chromatograph according to the comparative example, when the sample gas passes through the flow rate adjustment chamber, the pressure in the flow rate adjustment chamber temporarily drops, and the flow rate of the gas flowing into the column decreases. This temporary decrease in the flow rate of the gas flowing into the column is detected by the flow-rate-dependent detector, thereby causing valve shock.

In the example of FIG. 2, the valve shock is detected as a temporary drop in the baseline that precedes the peak corresponding to the component to be analyzed (target peak). However, when the target peak overlaps with the valve shock, the target peak becomes smaller compared to a case where the target peak can be accurately measured without overlapping with the valve shock. In a general chromatogram, the amount of a component is calculated based on the area of the target peak. Therefore, if the target peak overlaps with the valve shock and becomes smaller, the amount of the component will be calculated to be less than the actual amount. In particular, for a user not familiar with gas chromatograph measurement, there is a risk of misidentifying and misquantifying the component without noticing that the target peak overlaps with the valve shock.

Furthermore, in the field of gas chromatography, the demand for high-speed analysis has been increasing in recent years, and since a short column is used in high-speed analysis, the possibility that the target peak and the valve shock are detected overlappingly increases, and therefore, it is required to suppress the valve shock.

### Method for Introducing Sample Gas according to Embodiment

Therefore, in the gas chromatograph 1000 according to the present embodiment, before the sample gas flows into the flow rate adjustment chamber 30, the flow rate of the flow rate adjustment chamber 30 is adjusted to lower the pressure of the flow rate adjustment chamber 30 in advance, whereby valve shock can be suppressed.

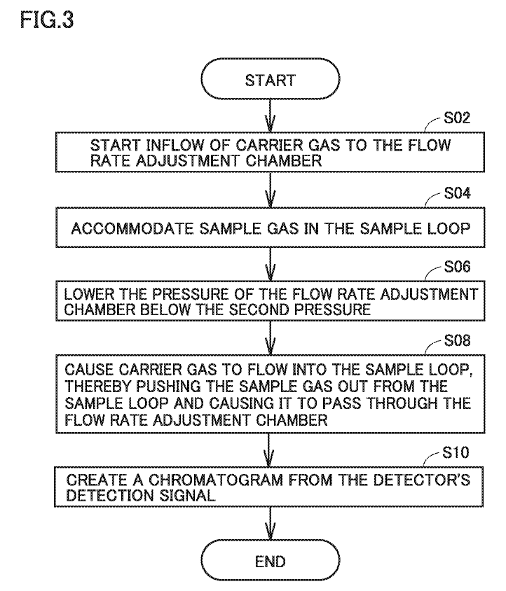

FIG. 3 is a flowchart showing a sample gas introduction process according to the embodiment. Each step (hereinafter also referred to as ST) of the flowchart of FIG. 3 is executed by the processor 91 of the controller 90.

With reference to FIG. 3, in ST02, the controller 90 starts the inflow of the carrier gas into the flow rate adjustment chamber 30. Specifically, the controller 90 causes the carrier gas at the second pressure to flow directly from the carrier gas supply unit 7 to the flow rate adjustment chamber 30.

In ST04, the controller 90 accommodates the sample gas at the first pressure in the sample loop 10.

In ST06, the controller 90 lowers the pressure of the flow rate adjustment chamber 30 below the second pressure. Specifically, for example, the controller 90 controls the solenoid valve 32 and increases the flow rate of the carrier gas discharged from the vent 31, thereby decreasing the flow rate of the carrier gas passing through the flow rate adjustment chamber 30. Thereby, the pressure of the flow rate adjustment chamber 30 is lowered below the second pressure. In this specification, a period in which the controller 90 decreases the flow rate passing through the flow rate adjustment chamber 30 and lowers the pressure of the flow rate adjustment chamber 30 below the second pressure is referred to as a pressure-lowering period, and a period before that is referred to as a pre-pressure-lowering period.

In ST08, the controller 90 causes the carrier gas to flow into the sample loop 10, thereby pushing the sample gas out from the sample loop 10 and causing it to pass through the flow rate adjustment chamber 30. The components of the sample gas that have passed through the flow rate adjustment chamber 30 are separated by the column 51 and detected by the detector 52.

In ST10, the controller 90 creates a chromatogram from the detection signal of the detector 52 and ends the process.

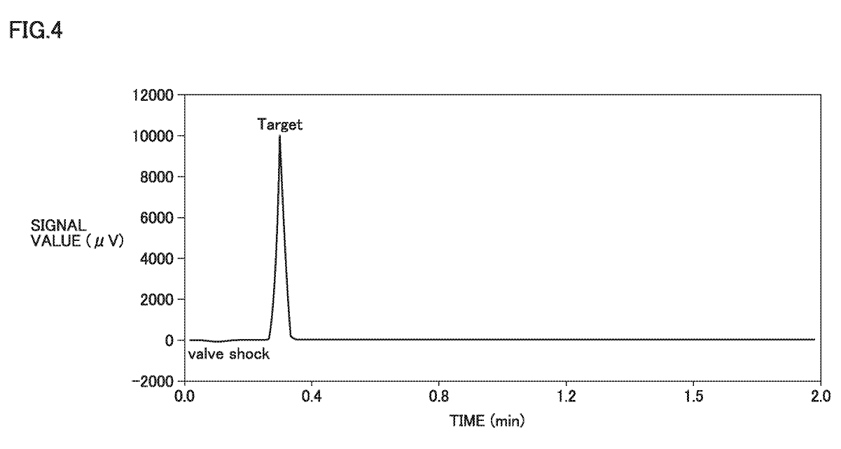

According to the process of FIG. 3, before the sample gas is introduced into the flow rate adjustment chamber 30, the pressure of the flow rate adjustment chamber 30 is lowered below the second pressure in advance. Thereby, the pressure of the flow rate adjustment chamber 30 approaches the first pressure, so that the pressure change when the sample gas at the first pressure is introduced into the flow rate adjustment chamber 30 can be reduced. Therefore, as shown in FIG. 4, valve shock can also be suppressed in the chromatogram. Thereby, it is possible to suppress valve shock and suppress a decrease in measurement accuracy of the gas chromatograph.

The timing of performing ST06 (the timing of decreasing the flow rate of the flow rate adjustment chamber 30) may be appropriately set within a range where the effect of the present embodiment is exhibited, as long as it is before the sample gas is introduced into the flow rate adjustment chamber 30. For example, the order of ST06 and ST04 may be reversed, and the pressure of the flow rate adjustment chamber 30 may be lowered below the second pressure before the sample gas is accommodated in the sample loop 10.

In ST08, when causing the sample gas to pass through the flow rate adjustment chamber 30, the solenoid valve 32 may be controlled to a more closed state than in ST06.

The present embodiment also includes a case where the solenoid valve 32 is set such that a small, constant amount of gas is exhausted from the vent 31 even before ST06 is performed. In such a case, the pressure of the carrier gas passing through the flow rate adjustment chamber 30 may be slightly lower than the pressure of the carrier gas discharged from the carrier gas supply unit 7 into the pipe 102. Further, when the cross-sectional area of the flow rate adjustment chamber 30 is larger than the cross-sectional areas of the pipes 102 and 106, the pressure of the carrier gas passing through the flow rate adjustment chamber 30 may be slightly lower than the pressure of the carrier gas discharged from the carrier gas supply unit 7 into the pipe 102. The second pressure in this specification is assumed to include, as an error, a pressure that is slightly lower or slightly higher than the pressure of the carrier gas at the time of being discharged from the carrier gas supply unit 7 as described above. In the present embodiment, as long as the pressure change in the flow rate adjustment chamber 30 at the time of sample gas injection can be reduced, the pressure of the flow rate adjustment chamber 30 in a state where the carrier gas is normally supplied and the pressure of the carrier gas supplied from the carrier gas supply unit 7 (the second pressure) do not necessarily have to be the same.

Similarly, depending on the setting of the solenoid valve 32, the pressure of the sample gas passing through the flow rate adjustment chamber 30 may be slightly lower than the pressure of the sample gas discharged from the sample loop 10 into the pipe 104. The first pressure in this specification is assumed to include, as an error, a pressure that is slightly lower or slightly higher than the pressure of the sample gas at the time of being discharged from the sample loop 10 as described above.

In any case, according to the present embodiment, the controller 90 can suppress the valve shock by increasing the flow rate of the carrier gas passing through the flow rate adjustment chamber 30 before the sample gas flows into the flow rate adjustment chamber 30, thereby lowering the pressure of the flow rate adjustment chamber 30 below the pressure in the pre-pressure-lowering period.

Note that some conventional gas chromatographs control the injection volume using a pressure monitoring device that monitors the pressure inside the sample loop. Specifically, for example, a configuration is known in which a pressure monitoring device is provided near the valve 13, and the opening and closing of the valve 13 are repeated until the pressure in the sample loop reaches a constant pressure. However, the pressure monitoring device has low resistance to many types of gases, and it is known that measuring any of these many types of gases leads to failure, so it is not often used. In this respect, the gas chromatograph 1000 according to the present embodiment is superior in that there is no restriction on the type of gas to be measured.

Note that a method of reducing valve shock by reducing the volume of the sample loop is also conceivable, but if the volume of the sample loop is reduced, the amount (absolute amount) of the sample gas introduced into the detector decreases, and the detected value becomes smaller by that amount. In particular, in the analysis of trace components in a sample gas, if the volume of the sample loop is reduced and the detected value becomes smaller, it may fall below the detection limit of the detector. In this respect, the gas chromatograph 1000 according to the present embodiment is superior in that it can reduce valve shock without reducing the sample loop volume.

### Aspects

Those skilled in the art will understand that the plurality of exemplary embodiments described above are specific examples of the following aspects.

### Item 1

A gas chromatograph according to a first aspect comprises a sample loop configured to accommodate a sample gas of a predetermined volume; a carrier gas supply unit connected to the sample loop and configured to cause a carrier gas at a second pressure higher than a first pressure to flow into the sample loop accommodating the sample gas at the first pressure; a flow rate adjustment chamber connected to the sample loop and the carrier gas supply unit and configured to adjust a flow rate of a gas passing therethrough; a column connected to the flow rate adjustment chamber and configured to separate components of the gas that has flowed in from the flow rate adjustment chamber; a detector connected to the column and configured to detect the components that have flowed in from the column; and a controller configured to adjust the flow rate of the gas passing through the flow rate adjustment chamber. The controller adjusts the flow rate of the flow rate adjustment chamber before the sample gas flows into the flow rate adjustment chamber, to lower a pressure of the flow rate adjustment chamber below the second pressure.

The gas chromatograph according to item 1 reduces the pressure change in the flow rate adjustment chamber at the time of sample gas injection by adjusting the flow rate of the gas passing through the flow rate adjustment chamber before the sample gas flows into the flow rate adjustment chamber and lowering the pressure of the flow rate adjustment chamber below the second pressure. This can suppress valve shock, in which the signal value of the chromatogram sharply changes due to the pressure change in the flow rate adjustment chamber. Therefore, it is possible to suppress valve shock and suppress a decrease in measurement accuracy of the gas chromatograph.

### Item 2

The gas chromatograph according to item 1 further comprises a flow rate adjustment vent configured to discharge a part of the gas that has flowed into the flow rate adjustment chamber to the outside; and a solenoid valve configured to adjust a flow rate of the gas discharged from the flow rate adjustment vent. The controller adjusts the flow rate of the gas passing through the flow rate adjustment chamber by controlling the solenoid valve.

The gas chromatograph according to item 2 can easily adjust the flow rate and pressure of the flow rate adjustment chamber by controlling the solenoid valve with the controller.

### Item 3

In a method for introducing a sample gas in a gas chromatograph according to a second aspect, the gas chromatograph comprises a sample loop having a predetermined volume, configured to accommodate a sample gas at a first pressure; a carrier gas supply unit connected to the sample loop and configured to supply a carrier gas at a second pressure higher than the first pressure; a flow rate adjustment chamber connected to the sample loop and the carrier gas supply unit and configured to adjust a flow rate of a gas passing therethrough; a column connected to the flow rate adjustment chamber and configured to separate components of the gas that has flowed in from the flow rate adjustment chamber; and a detector connected to the column and configured to detect the components that have flowed in from the column. The introduction method includes a step of accommodating the sample gas in the sample loop; a step of lowering a pressure of the flow rate adjustment chamber below the second pressure; and a step of causing the carrier gas to flow into the sample loop, thereby pushing the sample gas out from the sample loop and causing it to pass through the flow rate adjustment chamber.

The introduction method according to item 3 reduces the pressure change in the flow rate adjustment chamber at the time of sample gas injection by adjusting the flow rate of the gas passing through the flow rate adjustment chamber before the sample gas flows into the flow rate adjustment chamber and lowering the pressure of the flow rate adjustment chamber below the second pressure. This can suppress valve shock, in which the signal value of the chromatogram sharply changes due to the pressure change in the flow rate adjustment chamber. Therefore, it is possible to suppress valve shock and suppress a decrease in measurement accuracy of the gas chromatograph.

The embodiments disclosed this time should be considered as illustrative in all respects and not restrictive. The scope of the present invention is indicated by the claims rather than by the above description, and all changes that come within the meaning and range of equivalency of the claims are intended to be embraced therein.

### REFERENCE SIGNS LIST

1 Sampler, 3 Flow rate adjustment unit, 7 Carrier gas supply unit, 10 Sample loop, 11 Switching valve, 12 Pressure adjustment valve, 13 Valve, 30 Flow rate adjustment chamber, 31, 105 Vent, 32 Solenoid valve, 51 Column, 52 Detector, 90 Controller, 91 Processor, 92 Memory, 100 Analysis device, 101, 102, 103, 104, 106 Pipe, 1000 Gas chromatograph, 1001 First end, 1002 Second end, P1, P2, P3, P4, P5, P6 Port.

1. A gas chromatograph, comprising:
a sample loop configured to accommodate a sample gas of a predetermined volume;
a carrier gas supply unit connected to the sample loop and configured to cause a carrier gas at a second pressure higher than a first pressure to flow into the sample loop accommodating the sample gas at the first pressure;
a flow rate adjustment chamber connected to the sample loop and the carrier gas supply unit and configured to adjust a flow rate of a gas passing therethrough;
a column connected to the flow rate adjustment chamber and configured to separate components of the gas that has flowed in from the flow rate adjustment chamber;
a detector connected to the column and configured to detect the components that have flowed in from the column; and
a controller configured to adjust the flow rate of the gas passing through the flow rate adjustment chamber, wherein the controller adjusts the flow rate of the flow rate adjustment chamber before the sample gas flows into the flow rate adjustment chamber, to lower a pressure of the flow rate adjustment chamber below the second pressure.

2. The gas chromatograph according to claim 1, further comprising:
a flow rate adjustment vent configured to discharge a part of the gas that has flowed into the flow rate adjustment chamber to the outside; and
a solenoid valve configured to adjust a flow rate of the gas discharged from the flow rate adjustment vent, wherein the controller adjusts the flow rate of the gas passing through the flow rate adjustment chamber by controlling the solenoid valve.

3. A method for introducing a sample gas in a gas chromatograph, the gas chromatograph comprising: a sample loop having a predetermined volume, configured to accommodate the sample gas at a first pressure; a carrier gas supply unit connected to the sample loop and configured to supply a carrier gas at a second pressure higher than the first pressure; a flow rate adjustment chamber connected to the sample loop and the carrier gas supply unit and configured to adjust a flow rate of a gas passing therethrough; a column connected to the flow rate adjustment chamber and configured to separate components of the gas that has flowed in from the flow rate adjustment chamber; and a detector connected to the column and configured to detect the components that have flowed in from the column, the introduction method comprising:
a step of accommodating the sample gas in the sample loop;
a step of lowering a pressure of the flow rate adjustment chamber below the second pressure; and
a step of causing the carrier gas to flow into the sample loop, thereby pushing the sample gas out from the sample loop and causing it to pass through the flow rate adjustment chamber.
